(19) United States
(12) Patent Application Publication
(10) Pub. No.: US 2009/0026040 A1
(43) Pub. Date: Jan. 29, 2009

(54) Supply Unit for Feeding or Making Available Components, and Sorting Unit for Such Components

(76) Inventor: Heiko Schmidt, Lappersdorf (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/885,318

(22) PCT Filed: Feb. 27, 2006
(86) PCT No.: PCT/DE2006/000353

§ 371 Date: May 21, 2008

(30) Foreign Application Priority Data
Mar. 2, 2005 (DE) 20 2005 003 578.5
Mar. 8, 2005 (DE) 20 2005 003 851.2
Mar. 8, 2005 (DE) 20 2005 003 852.0

(51) Int. Cl. B65G 47/14

(52) U.S. Cl. 198/396

(57) ABSTRACT

Disclosed is a supply unit for feeding or making available components, e.g., punching nuts or similar joining elements. Said supply unit comprises a bin that forms a storage space and is used for stocking a random number of components, and a unit for removing the components from the storage space and redirecting the components in an oriented manner, among other things.

### BACKGROUND OF THE INVENTION

The invention relates to a supply unit for delivering or making available components, for example stamped nuts or similar connectors, for example, at a processing station and/or a processing tool, for example a stamping head, and to a sorting unit for sorting of components, for example stamped nuts or similar connectors on their outside contour with respect to their orientation.

Supply units, especially those for supplying so-called stamping heads with stamped nuts or similar connectors which are mounted with the respective stamping head by joining and pressing in components of sheet metal, for example in sheet metal motor vehicle parts, are known in different versions. In this connection, among others making available components in the stowage space of a receiver is known, for example of a bunker open on the top, as an unordered set or stock from which the components are then removed, for example using a removal element in the form of a step conveyor or by forming the bunker as a vibrating head, and after sorting in a given orientation are delivered to a further application.

It is an object of the invention is to devise a supply unit which with a simplified construction compared to conventional supply units has improved conveying performance. A sorting unit which is suited for use in the supply unit, but which can also be used in general for sorting of components with an outside contour which is suited as the sorting criterion, is also disclosed.

For the purposes of the invention, “conveying performance” is the number of components which is made available per unit of time for further use, for example for a processing tool.

### SUMMARY OF THE INVENTION

In the supply unit, the components travel via the inlet provided in the lower region of the stowage space into a removal unit or into at least one channel of this removal unit. The inlet and its cross section are matched to the contour and/or outside dimensions of the components such that only those components which at the inlet in an unordered set can purely randomly have a single orientation which is defined by the inlet or which have a first or second of two possible orientations there can travel via the inlet into at least one channel of the removal unit.

To enable entry of the components via the inlet into the removal unit, there are means which cause the components present in the stowage space of the bunker to move at least in the vicinity of the inlet. This can be done in the most different ways, for example by a corresponding movement of the removal unit itself, especially also relative to the bunker or the component receiver, and/or by movement of the component receiver or of the bunker, especially also relative to the removal unit, and/or by mechanical means which move the components in the stowage space, such as for example gripping or stirring arms, and/or by pneumatic movement of the components, for example by a compressed air jet emerging from at least one nozzle, etc. Combinations of one or more of the aforementioned measures are also conceivable.

In one preferred embodiment the removal unit or its inlet is made such that pre-sorting of the components by the removal unit takes place such that the components held by the removal unit have only given orientations each and that subsequently further sorting of the components takes place with reference to their orientation, such that the components made available for further processing ultimately have the same orientation. This further sorting with subsequent turning and/or alignment of the components takes place for example purely mechanically, pneumatically, electrically, opto-electrically etc.

In one preferred embodiment of the invention, further sorting or re-sorting takes place exclusively purely mechanically in at least one sorting channel in that the components as a result of their outside contour and their orientation are moved or conveyed by a corresponding cross sectional execution of the branching sorting channel to the outlet of the sorting unit which is assigned to their actual orientation.

In another possible embodiment of the supply unit as claimed in the invention, the inlet of the removal unit is made such that one hundred percent sorting of the components takes place there, i.e. the components removed from the removal unit each have a single, desired orientation. This is achieved for example in that at least one opening of the inlet is made as a mask which is matched to the outside contour of the components.

In the sorting unit as claimed in the invention, the sorting of the components takes place with respect to their orientation, i.e. at different outputs of the sorting unit components of one orientation are made available, the criterion for this sorting being the outside contour of the components. The components in one or more allowable orientations are supplied to the sorting channel, for example in a first or second of two allowable orientations. The first channel section of the sorting channel which forms the inlet of the sorting unit is then made such that its cross section is matched to components in all allowable orientations. On at least one branching region the sorting channel branches into at least two other channel sections, of which each is matched with respect to its cross section to the outside contour of the components such that only components reach each of the other channel sections which have the orientation assigned to the pertinent channel section which is then in turn at least one of the allowable orientations so that on at least one branching point the components of different orientations are each routed into further different channel sections. In one version of the invention these further branched channel sections form the outlets of the sorting unit. But fundamentally it is also possible that in at least one branched channel section which follows the first branching region another branching region with other branched channel sections follows so that sorting is then carried out in a step form with single-step or multi-step pre-sorting and end sorting.

### BRIEF DESCRIPTION OF THE DRAWINGS

The invention is detailed below on embodiments using the figures in which for better understanding the three spatial axes X, Y and Z which are oriented at a right angle to one another are shown.

FIG. 1 shows in positions a and b a component or connector in the form of a so-called stamped nut in two different views;

FIG. 2 shows in a simplified representation a supply means for delivering stamped nuts to a tool which is not shown and which processes these nuts (for example a stamping head);

FIG. 3 shows in a simplified representation a partial section through a removal unit for removing the stamped nuts from a stock of stamped nuts;

FIGS. 4 and 5 show sections through the sorting unit of the supply means of FIG. 2;

FIG. 6 shows in a representation similar to FIG. 2 another possible embodiment;

FIG. 7 shows in a schematic and a side view a supply means for delivering stamped nuts to a tool which is not shown and which processes these nuts (for example stamping head);

FIG. 8 shows in a simplified partial representation a section in the region of the charging bunker and the step conveyor of the supply unit of FIG. 2;

FIG. 9 shows a cross section according to line I-I of FIG. 3; and

FIGS. 10-12 show the sorting means of the supply unit in an individual representation and in different sections.

### DETAILED DESCRIPTION OF THE INVENTION

In the figures there are so-called stamped nuts 1 which can be mounted in workpieces 2 of sheet metal by joining and pressing. Each stamped nut 1 consists conventionally of a circular cylindrical nut body 3 with a threaded hole 4. On one face the nut body 3 is provided with an essentially circularly cylindrical projection 5 which is located coaxially with the axis of the stamped nut and which is used for anchoring in the workpiece.

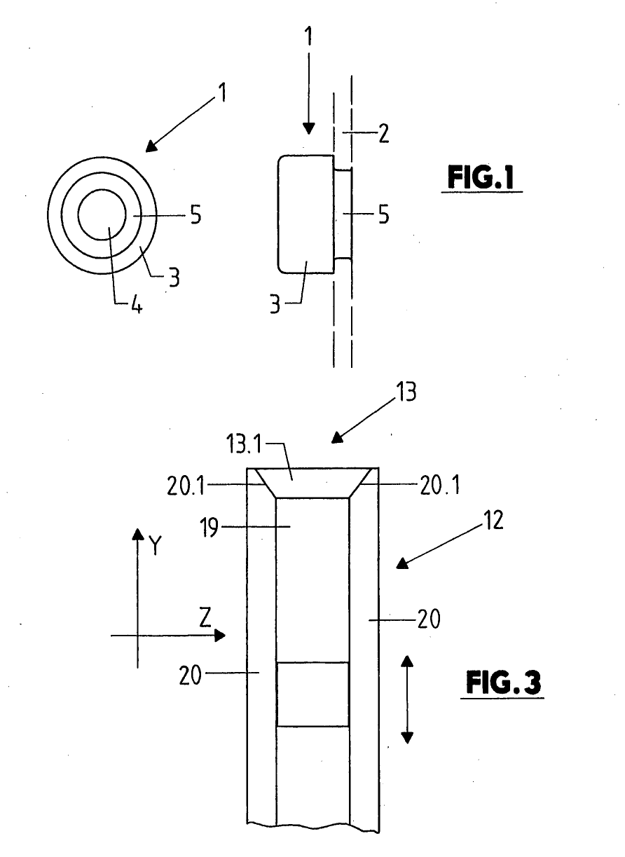

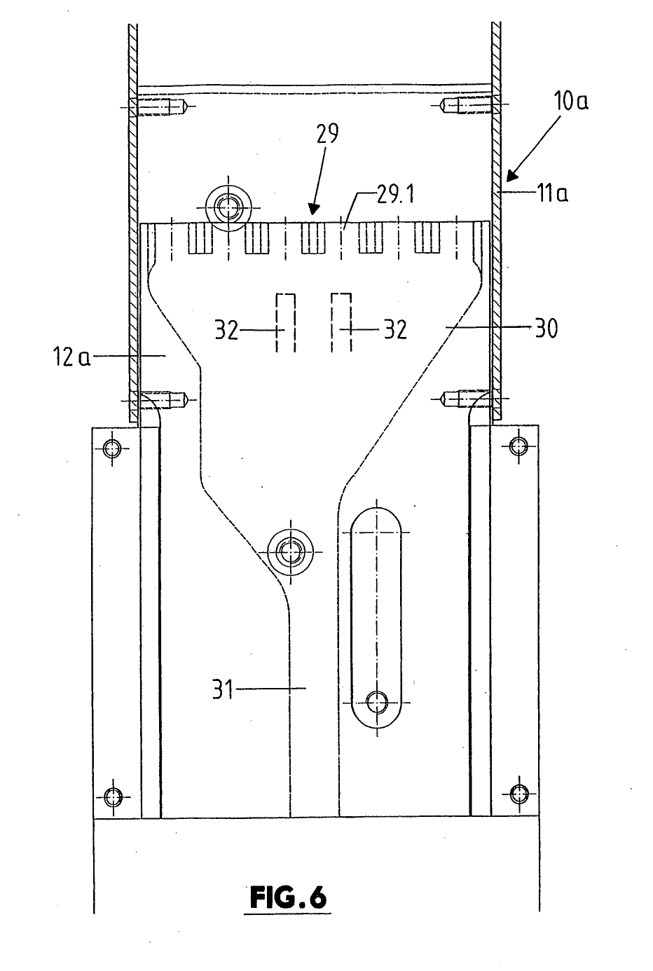

To supply the stamped nuts 1 to tools which are not shown, but which are known to one skilled in the art, for example stamping heads, the supply unit labelled in general 10 in FIGS. 1-6 is used; it has a bunker 11 open on the top for holding a stock of stamped nuts in the form of a unordered set, on a machine frame which is not shown.

On the bunker 11 there is a removal element or a removal unit 12 with which those stamped nuts 1 are removed from the stock in the bunker 11 which are located at the inlet 13 or the opening 13.1 of the removal device 12 there and which have a first or second orientation of two possible orientations randomly there. The removal unit 12 is connected to a sorting unit 14 via which these stamped nuts 1 which already have the desired first orientation travel directly into a magazine 15, while those stamped nuts 1 which have the second of the two possible orientations are supplied to this magazine turned in a turning means 16. Via the outlet channel 17 the stamped nuts 1 are then relayed to the different machining tools (stamping heads), for example by conveying air or blast air, via supply hoses, and maintaining the first orientation.

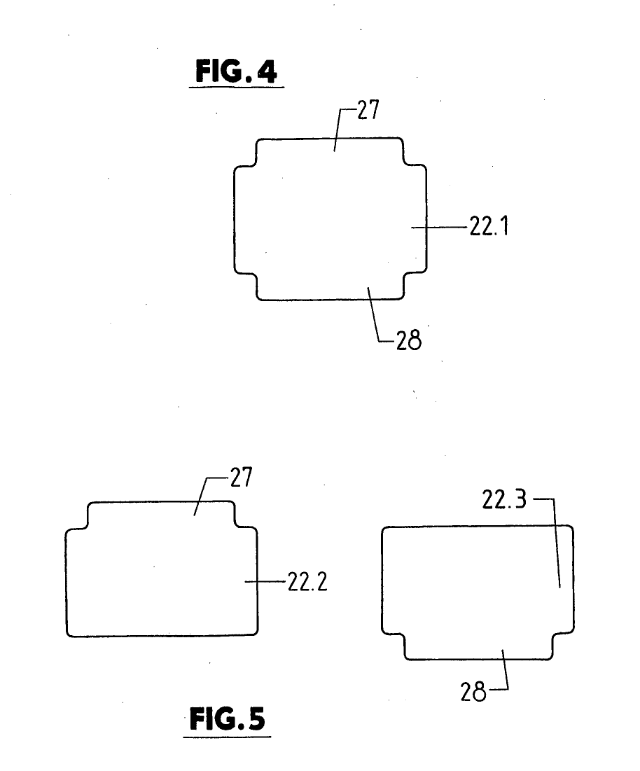

The removal unit 12 which extends with its inlet formed by the slotted opening 13.1 from underneath into the stowage space or interior of the bunker and into the unordered set of stamped nuts 1 there forms a shaft 19 which is rectangular in cross section, which is part of the inlet and widens somewhat toward the edge of the opening 13.1, specifically on the edge region 20.1 of the wall of the shaft 19. The cross section of the shaft 19 perpendicular to the two walls 20 which are located in the XY plane is the same or slightly larger than the axial length of the stamped nuts 1 so that each stamped nut 1 which travels via the inlet 13 into the shaft 19 can have only a first or a second of two possible orientations, i.e. for example in the representation chosen for FIG. 3 it is adjacent either with its respective projection 5 to the left wall there or the right wall 20 there, in any case however is located with its axis in the Z-axis.

The shaft 19 discharges via shaft sections 19.1 and 19.2 which taper in the manner of a funnel into a channel 21 which extends down in the vertical direction (Y-axis). These channels 21 which are formed like the shaft 19 in the housing of the removal unit in the X axis have a width equal to the diameter or somewhat larger than the diameter of the stamped nuts 1 or the nut body 3 so that in the channels 21 the stamped nuts 1 are arranged vertically in a row in succession, but furthermore in the first or second orientation.

A drive which is not shown in the illustrated embodiment can move the removal unit 12 up and down in the vertical direction, i.e. in the direction of the Y-axis so that in this way movement of the stock of stamped nuts takes place at least also in the vicinity of the inlet 13 to the shaft 19 and in this way the stamped nuts 1 travel continuously into the shaft 19 and from there into the channels 21.

Via the channels 21 the stamped nuts 1 are supplied to one sorting channel 22 of the sorting unit 14 at a time, and via a connection 23 between the removal unit 12 and the sorting unit 14, which (connection 23) enables vertical motion of the removal unit 12 (double arrow A) up and down when the sorting unit 14 is located fixed on the device frame.

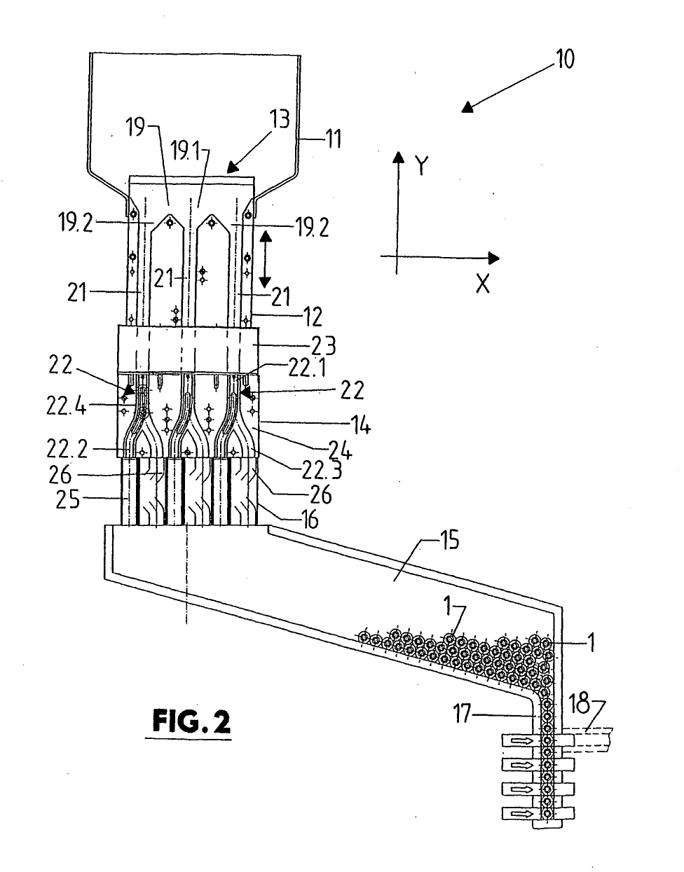

According to the number of channels 21, there are a total of three sorting channels 22 in the sorting unit or in the housing 24 of this unit. Each sorting channel 22 has three channel sections 22.1-22.3, specifically the channel section 22.1 which is connected to the connection 23 or to the preceding channel 21, and the two branching channel sections 22.2 and 22.3, of which the channel section 22.2 discharges directly into the magazine 15 via a continuous channel 25, i.e. one which does not turn, i.e. via the channels 25 those stamped nuts 1 are routed directly to the magazine 15 which have the orientation necessary for further processing. i.e. in the representation chosen for FIG. 2 are oriented with their nut axis perpendicular to the XY-plane and have their projection on the side which is visible in FIG. 2. Each channel section 22.3 discharges via a helical turning channel 26 into the magazine 15, i.e. those stamped nuts 1 which have a second of the two possible orientations in the channel section 22.3 travel turned via the channel section 22.3 and the turning channel 26, i.e. then likewise in the correct first orientation into the magazine 15.

The channel 22 has altogether, i.e. on its collective channel sections 22.1-22.3 and also on a branching area 22.4 on which the two channel sections 22.2 and 22.3 run apart or branch, in each case the same rectangular cross section which is slightly larger than the axial height and the diameter of the cylindrical stamped nut body 3 without the projection 5. On the channel section 22.1 as far as the branching region 22.4 the rectangular cross section of the channel 22 on the two larger cross section sides has one groove-shaped widening 27 and 28 which forms the space for movement for the projections 5 of the stamped nuts 1, regardless of the orientation of the respective stamped nuts 1 and of the respective projection 5.

The groove-shaped widening 27 continues beyond the branching region 22.4 within the channel section 22.2 so that the channel 22 there according to FIG. 5 has a rectangular cross section with only one widening, specifically the widening 27 on one cross sectional side, i.e. for the representation chosen for FIG. 5 on the upper larger cross sectional side. In this way only those stamped nuts 1 which are oriented such that the projections are held in the widening 27 are routed into the channel section 22.2. Analogously the widening 28 continues via the branching region 22.4 into the channel section 22.3 so that the rectangular cross section of this channel section also has only one widening, specifically the widening 28, but on the other larger cross sectional side, i.e. in the representation shown for FIG. 5 on the lower cross sectional side. Only those stamped nuts 1 which are oriented accordingly with reference to their projection 5, i.e. their projections are held in the widening 28 of the channel 22, are routed on their projection into the channel section 22.3 and are conveyed onward there with their projection sliding in the widening 28, i.e. supplied to the turning channel 26.

The stamped nuts 1 are thus sorted with the sorting unit 14 alone by the shape of the sorting channels 22 and without using active or driven sorting elements, etc. The stamped nuts are conveyed in the sorting unit 14 by gravity in the illustrated embodiment. But other versions are also possible, especially also those in which the conveyance of the stamped nuts 1 in the sorting unit 14 takes place for example by blast air.

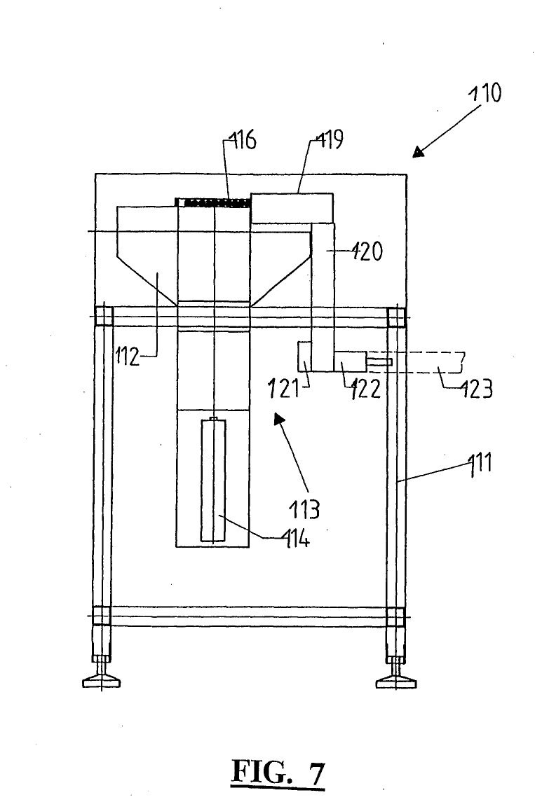

FIG. 6 shows as another possible embodiment a supply unit 10a which differs from the supply unit 10 among others in that the inlet 29 of the removal unit 12a there is formed by a plurality of openings 29.1 with a cross section chosen such that only those stamped nuts 1 which have the required first orientation in the region of one of the openings 29, i.e. not only with their nut axis perpendicular to the plane of the drawings of FIG. 6, i.e. are oriented perpendicular to the XY plane, but their projections 5 are also located on the front side which is visible in FIG. 6, travel into the removal unit 12a or its shaft 30, while the stamped nuts 1 which do not have this orientation cannot travel into the shaft 30 and out of it into the vertical channel 31 either. The cross sections of the shaft 30 and of the channel 31 are chosen such that the stamped nuts 1 necessarily retain their orientation so that the stamped nuts 1 can be delivered directly into the magazine 15 or another unit via the channel 31 without the necessity of a sorting unit.

To avoid blockage of the openings 29.1 by incorrectly oriented stamped nuts 1 which have been retained in these openings, in this version there is a clearing and loosening element which periodically clears the openings 29, which loosens the stock of stamped nuts via masks or openings 29 and which is made for example rake-like, as is indicated in FIG. 6 with broken lines at 32.

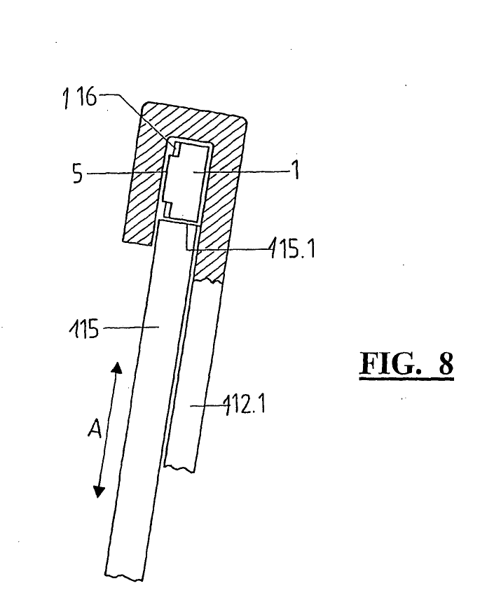

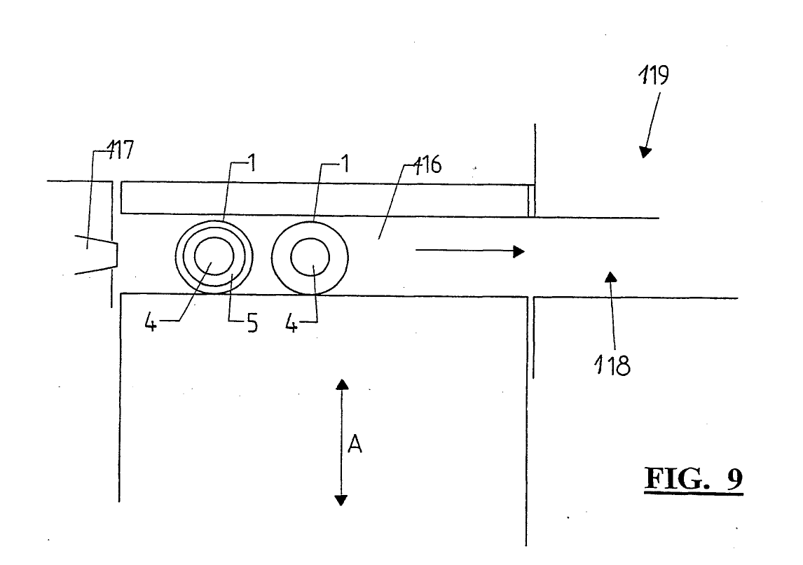

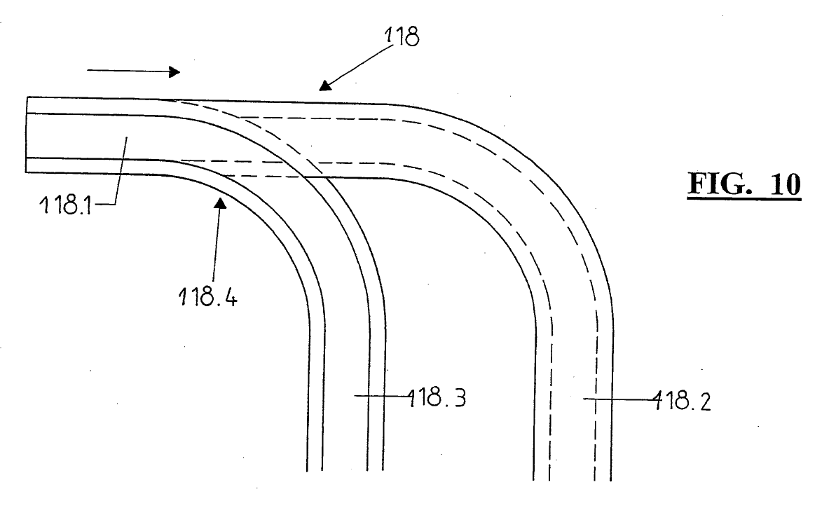

In FIGS. 7-12 there is in turn a so-called stamped nut 1 which can be mounted in workpieces 2 of sheet metal by joining and pressing. The stamped nut 1 consists in the conventional manner of a circularly cylindrical nut body 3 with a threaded hole 4. On one end side the nut body 3 is provided with an essentially circularly cylindrical projection 5 which is coaxial with the axis of the stamped nut and which is used for anchoring in the workpiece 2.

To supply the stamped nuts 1 to a processing tool which is not shown, for example to a stamping head which is not shown but which is known to one skilled in the art, the supply unit labelled 110 in general in the Figures is used which has a bunker 112 which is open on the top for holding a stock of stamped nuts 1 as an unordered set on a frame 111.

The bunker 112 is made with a step conveyor 113; its essential component is a sword-shaped conveyor element 115 (double arrow A) which can be moved up and down along a sloped wall 112.1 by a drive 114, which in each down stroke dips into the stock of stamped nuts 1 present in the bunker 112 with an upper, strip-like driver surface 115.1 and for each up stroke entrains a random number of stamped nuts 1 out of this stock. The strip-like driver surface 115.1 extends along the bunker wall 112.1 in the horizontal or almost horizontal direction and for the illustrated embodiment is slightly tilted transversely to its lengthwise extension relative to the horizontal. By the corresponding execution of the driver surface 115.1 provision is made for only those stamped nuts 1 being moved when the conveyor element 115 moves up which already have one of only two possible orientations, i.e. with one of its two end surfaces lie adjacent to the inner surface of the bunker wall 112.1, therefore either with the projection 5 or with the face side without the projection which faces away from the projection 5 lie against the inner surface of the bunker wall 112.1 and thus with their nut axis are oriented perpendicular to the bunker wall 112.1, while all differently oriented stamped nuts 1 fall back into the stock.

The stamped nuts 1 entrained on the driver surface 115.1 are finally delivered from underneath into a feed channel 116 which is formed on the top edge of the bunker wall 112.1, and which when the conveyor element 115 is in the up stroke position is closed by it. On one side of the feed channel 116 there is a nozzle 117 via which in the lengthwise direction of the feed channel blast air can be delivered in a controlled manner into the channel 116 so that via this blast air the stamped nuts 1 conveyed from the conveyor element 115 in the feed channel 116 are conveyed in the conveyor direction radially to their nut axis into one channel 118 of a sorting means 119. Subsequently, with the blast air turned off the conveyor element 115 is again moved down, for repeated dipping into the stock of stamped nuts and for subsequent entrainment of other stamped nuts up into the feed channel 116.

The sorting means 119 is made such that only those stamped nuts 1 which have a given identical orientation with reference to their projection 5 travel via the sorting means 119 into the vertical channel of a delivery rail 120 in which then the individual stamped nuts 1 are arranged oriented in a row in secession and with their projection 5 each in the same direction perpendicular to the lengthwise extension of the delivery rail. The bottom end of the delivery rail 120 is then connected to separation means 121 via which the stamped nuts 1 each travel to a hose coupling 122 while maintaining the given orientation.

From the hose coupling the stamped nuts 1 using conveyor air or blast air via a flexible supply hose 123 are supplied to the processing tool, for example (stamping head) individually in secession or as a group of several stamped nuts, by corresponding execution of the channel in the supply hose 123 the stamped nuts 1 also being located there with their nut axis perpendicular to the conveyor direction and retaining the given orientation. These stamped nuts which do not have the required orientation when entering the sorting means 119 travel via the sorting means 119 back into the bunker 112.

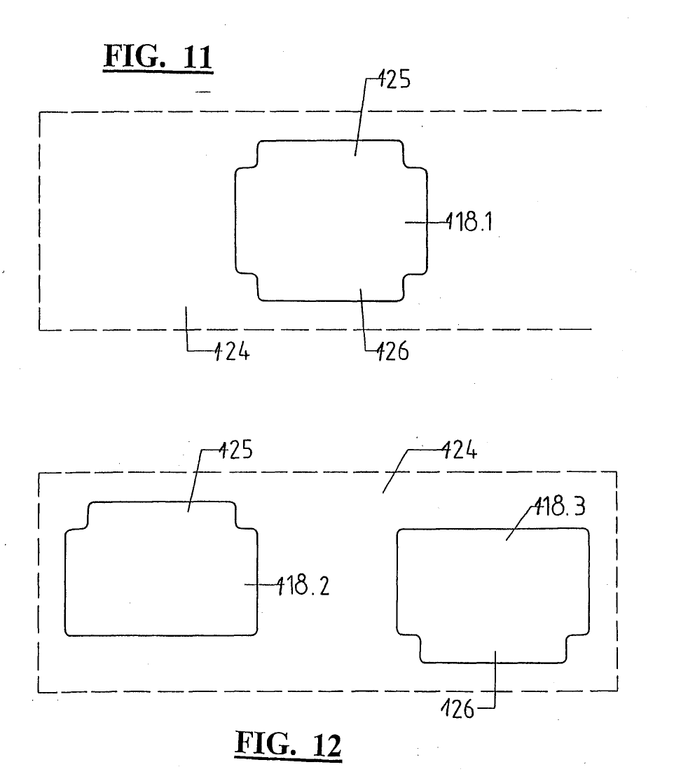

FIGS. 10-12 show one possible version for the sorting means. As the figures show, the sorting means 119 consists essentially of a branching channel 118 which is formed in the housing 124. It has a channel section 118.1 which is connected to the feed channel 116 and which forms the inlet of the sorting means 119 and the two branching channel sections 118.2 and 118.3, of which the channel section 118.2 discharges into the vertical channel of the delivery rail 120 and the channel section 118.3 is used to return the incorrectly oriented stamped nuts 1 to the bunker 112.

The channel 118 has altogether, i.e. on its collective channel sections 118.1-118.3 and also on a branching area 118.4, in each case the same rectangular cross section which is slightly larger than the height and the diameter of the cylindrical stamped nut body 3 without the projection 5. On the channel section 118.1 as far as to the branching region 118.4 the rectangular cross section of the channel 118 on the two larger cross section sides has one groove-shaped widening 125 and 126 which forms the space for movement for the projections 5 of the stamped nuts 1, regardless of the orientation of the respective stamped nut 1 and of the respective projection 5.

The groove-shaped widening 125 extends beyond the connecting region 118.4 within the channel section 118.2 so that the channel 118 there has a rectangular cross section with only one widening, specifically the widening 125 on one larger cross sectional side, and thus only those stamped nuts 1 which are oriented accordingly with reference to their projection 5, i.e. their projections are held in the widening 125, are routed into the channel section 118.2 on their projection 5 and are further conveyed there with their projection in the widening 125 by sliding.

The widening 126 continues via the connecting region 18.4 into the channel section 118.3 so that the rectangular cross section of this channel section also has only one widening, specifically the widening 126 on the other larger cross sectional side, and thus only those stamped nuts 1 which are oriented accordingly with reference to their projection 5, i.e. their projections are held in the widening 126, are routed on their projection 5 into the channel section 118.3 and are conveyed onward there with their projection sliding in the widening 28, i.e. conveyed back into the bunker 112.

The stamped nuts 1 are thus sorted for the sorting means 119 solely by the shape of the channel 118 and without using active or driven sorting elements, etc. The stamped nuts 1 are conveyed in the sorting means 119 by blast air and also supported by gravity. But other versions are also possible, especially also those in which the conveyance of the stamped nuts 1 in the sorting means takes place solely by gravity.

The invention was described above using embodiments. It goes without saying that numerous changes and modifications are possible without in this way departing from the inventive idea underlying the invention.

Thus, in conjunction with FIGS. 1-6 it was assumed above that the respective removal unit 12 and 12a is moved in the vertical direction. Of course also movement of the respective removal unit 12 or 12a in the other axial direction or in addition in at least one other axial direction is possible. Furthermore it is possible to move the respective bunker 11 or 11a with the stock of stamped nuts 1 contained in this bunker relative to the removal element 12 or 12a or its inlet 13 or 29 in at least one axial direction.

Furthermore it is also possible by the corresponding measures, for example by a mechanical means and/or by blast or compressed air to move or keep the stamped nuts 1 in the bunker 11 and 11a in motion in order to always obtain a sufficient amount of randomly correctly oriented stamped nuts 1 at the pertinent inlet 13 and 20, which then travel via the inlet 13 or via the openings 29 into the removal means 12 and 12a.

Furthermore it also possible to make the sorting means 119 differently than described above or such that the incorrectly oriented stamped nuts 1 are not returned to the bunker 112, but are turned by a turning means which then follows the channel section 118.3 so that they then have the given orientation and are supplied together with the already originally correctly oriented stamped nuts to further processing.

### REFERENCE NUMBER LIST

1 stamped nut
2 sheet metal workpiece.
3 stamped nut body
4 threaded hole
5 projection
10, 10a supply unit
11, 11a bunker
12, 12a removal element or removal unit
13 inlet
13.1 opening
14 sorting unit
15 magazine
16 turning unit
17 outlet channel
18 supply hose
19 shaft
19.1, 19.2 shaft section which tapers in a funnel shape
20 wall
20.1 bevelled region of the inside surface of the wall 20
21 channel
22 sorting channel
22.1, 22.2, 22.3 channel section
22.4 branching region
23 channel
24 housing
25 channel
26 turning channel
27, 28 widening
29 inlet
29.1 opening or mask
30 shaft
31 channel
32 means for loosening and removing stamped nuts
110 supply unit
111 frame
112 bunker
112.1 bunker wall
113 step conveyor
114 drive
115 sword-like conveyor element of the step conveyor
115.1 strip-like conveyor or driver surface of the conveyor element 15
116 receiving or charging channel
117 nozzle for blast or conveyor air
118 channel of the sorting means
118.1, 118.2, 118.3 channel section
118.4 branching region
119 sorting means
120 delivery rail
121 separation
122 hose coupling
123 supply hose
124 housing
125, 126 groove-like widening of the channel of the sorting means
Double arrow A motion stroke of the conveyor element 15

What is claimed is:

1. A supply unit for delivering or making available components, stamped nuts or similar connectors, comprising a bunker which forms a stowage space for holding a stock of components in an unordered set, and with a removal unit which has one sorting means for removing the components from the stowage space and for oriented relaying of the components.

2. The supply unit as claimed in claim 1, wherein the removal unit has at least one channel which discharges via at least one inlet into the stowage space for routing the components removed from the stowage space away,
wherein the inlet and/or the channel in cross section are matched to an outside contour of the components such that only the components at the inlet which have at least a given orientation, travel via the inlet into the channel and are relayed there while maintaining the orientation, and
wherein there are means for moving the components in the stowage space at least in the region of the inlet.

3. The supply unit as claimed in claim 2, wherein the means for moving the components in the stowage space are formed by a removal unit which can be moved by a drive in at least one axial direction.

4. The supply unit as claimed in claim 2, wherein the means for moving the components are formed by a bunker which is moved by a drive in at least one axial direction.

5. The supply unit as claimed in claim 2, wherein the means for moving the components are formed by at least one exit nozzle for compressed or blast air.

6. The supply unit as claimed in claim 2, wherein the means for moving the components are formed by by at least one element which is moved mechanically through the stowage space.

7. The supply unit as claimed in claim 2, wherein an inlet of the removal unit is formed by an opening which is oriented horizontally or almost horizontally with its opening cross section.

8. The supply unit as claimed in claim 2, wherein an inlet of the removal unit is formed by at least one shaft which is open via a removal opening to the stowage space of the bunker and discharges into at least one channel, via a shaft sections which tapers in the manner of a funnel.

9. The supply unit as claimed in claim 2, wherein the channel of the removal unit extends over at least a partial length in the vertical direction, and wherein the conveyance of the components takes place by gravity in this partial section.

10. The supply unit as claimed in claim 1, wherein the removal unit or its inlet are made such that only components which have a single orientation travel through an opening matched to the outside contour of the components into the removal unit.

11. The supply unit as claimed in claim 1, wherein the removal unit or its inlet are made such that only components which have a first or a second of two allowable orientations travel via the inlet into at least one channel of the removal unit.

12. The supply unit as claimed in claim 1, further comprising a sorting unit which is connected in the transport direction of the components to the removal unit, with at least one inlet to which the components in at least one of several allowable orientations are delivered, and with at least two outlets on which the components are made available for further use in an orientation which is different from outlet to outlet.

13. The supply unit as claimed in claim 12, wherein the sorting unit has at least one sorting channel with a first channel section which forms a component inlet and which has a cross section which matches the outside contour of these components with at least one of at least two possible orientations, and which branches at least one branching region into at least two other branched channel sections, of which each in cross section is matched to the outside contour of the components such that only components which in their orientation correspond to the cross section of the branched channel section travel into each branched channel section.

14. The supply unit as claimed in claim 13, wherein the branched channel sections which are connected to at least one branching region have different cross sections.

15. The supply unit as claimed in claim 13, wherein the cross section of the first channel section matches the outside contour of the components which have a first or a second of two possible orientations, and wherein the branched channel sections which are connected to at least one branching region with respect to their cross section are made to match the components only of the first or second orientation.

16. The supply unit as claimed in claim 13, wherein when using components with an outside contour imprinted by at least one extremity on the outside surface of a component the first channel section has a cross section which corresponds to the component body without the extremity and which additionally for the allowable orientations of the components at least two cross sectional sides has a widening which is matched to the extremity, and wherein each widening on the branching region continues only into one of the branched channel sections of the sorting channel.

17. The supply unit as claimed in claim 16, wherein when using components which have a projection on the outside surface of a component body the cross sectional widenings are grooves.

18. The supply unit as claimed in claim 13, wherein the cross section of the sorting channel is made essentially rectangular with widenings in the first channel section and in the branched channel sections.

19. The supply unit as claimed in claim 13, wherein a turning means, for example a turning channel, is connected to one of the branched channel sections.

20. The supply unit as claimed in claim 13, wherein at least one sorting channel is oriented essentially such that the components are moved through this channel or its channel sections by gravity.

21. The supply unit as claimed in claim 13, further comprising means for moving the components through at least one sorting channel.

22. A sorting unit for sorting of components stamped nuts or similar connectors with respect to their orientation on the outside contour of the components, comprising at least one sorting channel with a first channel section which forms a component inlet, with a cross section which matches the outside contour of these components with at least one of two possible orientations, and which branches at least one branching region into at least two other branched channel sections, of which each in cross section is matched to the outside contour of the components such that only components which in their orientation correspond to the cross section of the branched channel section travel into each branched channel section.

23. The sorting unit as claimed in claim 22, wherein the branched channel sections which are connected to at least one branching region have different cross sections.

24. The sorting unit as claimed in claim 22, wherein the cross section of the first channel section matches the outside contour of the components which have a first or a second of two possible orientations, and wherein the branched channel sections which are connected to at least one branching region with respect to their cross section are made to match the components only of the first or second orientation.

25. The sorting unit as claimed in claim 22, wherein when using components with an outside contour imprinted by at least one extremity on the outside surface of a component the first channel section has a cross section which corresponds to the component body without the extremity and which additionally for the allowable orientations of the components at least two cross sectional sides has a widening which is matched to the extremity, and wherein each widening on the branching region continues only into one of the branched channel sections of the sorting channel.

26. The sorting unit as claimed in claim 25, wherein when using components which have a projection on the outside surface of a component body the cross sectional widenings are grooves.

27. Sorting The sorting unit as claimed in claims claim 22, wherein the cross section of the sorting channel is made essentially rectangular with widenings in the first channel section and in the branched channel sections.

28. The sorting unit as claimed in claim 22, wherein a turning means is connected to one of the branched channel sections.

29. The sorting unit as claimed in claim 22, wherein at least one sorting channel is oriented essentially such that the components are moved through this channel or its channel sections by gravity.

30. The sorting unit as claimed in claim 22, further comprising means for moving the components through at least one sorting channel.

31. The sorting unit as claimed in claim 22, wherein for delivering components, stamped nuts or similar connectors, to a processing station and/or a processing tool, a stamping head, the supply unit comprises at least the following:
a bunker for holding a stock of components in an unordered set,
at least one step conveyor with at least one conveyor element for removing components from the stock and for pre-sorted transfer of components to a transport section,
at least one feed channel which is provided on the step conveyor and into which the components entrained with the conveyor element are moved, and
at least one nozzle on the feed channel for blast or conveying air for conveying the components out of the feed channel to at least one following transport section.

32. The supply unit as claimed in claim 31, wherein a channel of the transport section is connected to one end of the feed channel and wherein there is at least one exit nozzle for blast or conveying air on the end of the feed channel which is away from the channel.

33. The supply unit as claimed in claim 31, wherein at least one conveyor element of the step conveyor is a sword-shaped conveyor element with a strip-like driver or conveyor surface.

34. The sorting unit as claimed in claim 31, wherein the conveyor element of the step conveyor in the upper position of its stroke motion extends from underneath into the feed channel and/or at least partially closes it on the bottom.

35. The sorting unit as claimed in claim 31, wherein adjoining the feed channel in one conveying direction of the components there is a sorting means via which these components which do not have a given orientation are returned to the bunker or are re-oriented in a turning means.

36. The sorting unit as claimed in claim 31, wherein the step conveyor is made for pre-sorting of the components so that they have only one or a second of two possible orientations in the feed channel.

37. The supply unit as claimed in claim 35, wherein the sorting means has at least one channel with a first channel section which forms the inlet of the sorting means and which branches at the branching region into at least one second channel section and into a third channel section, wherein the cross section of the first channel section is made to match those components which have a first or a second of only two possible orientations, wherein the cross section of the second channel section is made to match only components of the first orientation and the cross section of the third channel section is made to match only components of the second orientation.

38. The supply unit as claimed in claim 37, wherein when using components with two differently shaped sides opposite one another in one axial direction perpendicular to the conveyor direction the first channel section on two opposing sides is made to match the two sides of the components, the second and third channel section however are made only to match one side of the components at a time.

39. The sorting unit as claimed in claim 37, wherein when using components in the form of stamped nuts or other components which have at least one projection on one side, the first channel section has a cross section with at least one groove-shaped widening on two opposing cross sectional sides for the projection of the components, and wherein each groove-shaped widening continues only in one of the other channel sections.
